(19) United States
(12) Patent Application Publication
(10) Pub. No.: US 2025/0308037 A1
(43) Pub. Date: Oct. 2, 2025

(54) MOTION VECTORS BASED ON DYNAMIC MAXIMUM SUPPORTED MOTION

(71) Applicant: ADVANCED MICRO DEVICES, INC., Santa Clara, CA (US)

(72) Inventors: Colin Riley, Milton Keynes (GB); Krzysztof Jacek Kaminski, Gdynia (PL)

(21) Appl. No.: 18/616,790

(22) Filed: Mar. 26, 2024

(51) Int. Cl. G06T 7/238; G06T 7/246

(52) U.S. Cl. CPC G06T 7/238; G06T 7/248

(57) ABSTRACT

A processing system determines, based on one or more dynamic parameters, a maximum supported motion for one or more input frames to an optical flow process. The processing system then adjusts the maximum limits of the optical flow process based on the maximum supported motion. The processing system thus tailors the limits of the optical flow process based on the expected amount of motion present in the one or more frames, thus making more efficient use of processor resources in the generation of the motion vectors.

### BACKGROUND

Image processing and other applications sometimes rely on optical flow information, and in particular motion vectors, to identify movement of features between image frames. For example, some video compression techniques employ motion vectors to assist in representing a sequence of image frames with a relatively small amount of data. However, generating the motion vectors is often computationally intensive. For example, some optical flow techniques generate motion vectors via a computationally intensive process of identifying matching pixels, or sets of pixels, between input images. It is difficult to effectively implement these optical flow approaches without expensive or advanced computer hardware, or without consuming a high amount computing resources, such as power or compute cycles.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that dynamically adjusts a maximum supported motion of an optical flow process to generate motion vectors in accordance with some embodiments.

FIG. 2 is a block diagram of a graphics pipeline implemented by an accelerator unit of FIG. 1, in accordance with some embodiments.

FIG. 3 is a block diagram illustrating an example of the processing system of FIG. 1 employing dynamic parameters to set a maximum supported motion for an optical flow process in accordance with some embodiments.

FIG. 4 is a diagram illustrating an example of the processing system of FIG. 1 changing a search range of an optical flow process based on a dynamic maximum supported motion in accordance with some embodiments.

FIG. 5 is a diagram illustrating an example of the processing system of FIG. 1 changing a block size of an optical flow process based on a dynamic maximum supported motion in accordance with some embodiments.

FIG. 6 is a flow diagram illustrating a method for changing the maximum supported motion for an optical flow process for different input frames and based on one or more dynamic parameters in accordance with some embodiments.

### DETAILED DESCRIPTION

An optical flow process is a module (e.g., set of software instructions or circuitry) configured to receive multiple related input frames, and to output a series of motion vectors describing how objects or other features are moving between those input frames. The motion vectors are used for any of a number of image processing tasks, such as image compression or object tracking, in an image processing pipeline. The optical flow process compares sets of pixels of one image to pixels of another image to identify matching features between the images, determining the positional difference between the matching features, and generates the motion vectors based on the positional difference. The operations of the optical flow process are based on specified maximum limits that govern the size of the sets of pixels being compared (that is, a pixel block size), the range of pixel blocks used for comparison (referred to as the search range), and the like. Conventionally, these maximum limits are typically static values, such that the same pixel block size, search range, and other limits are the same for all input frames. This can lead to inefficient use of processor resources.

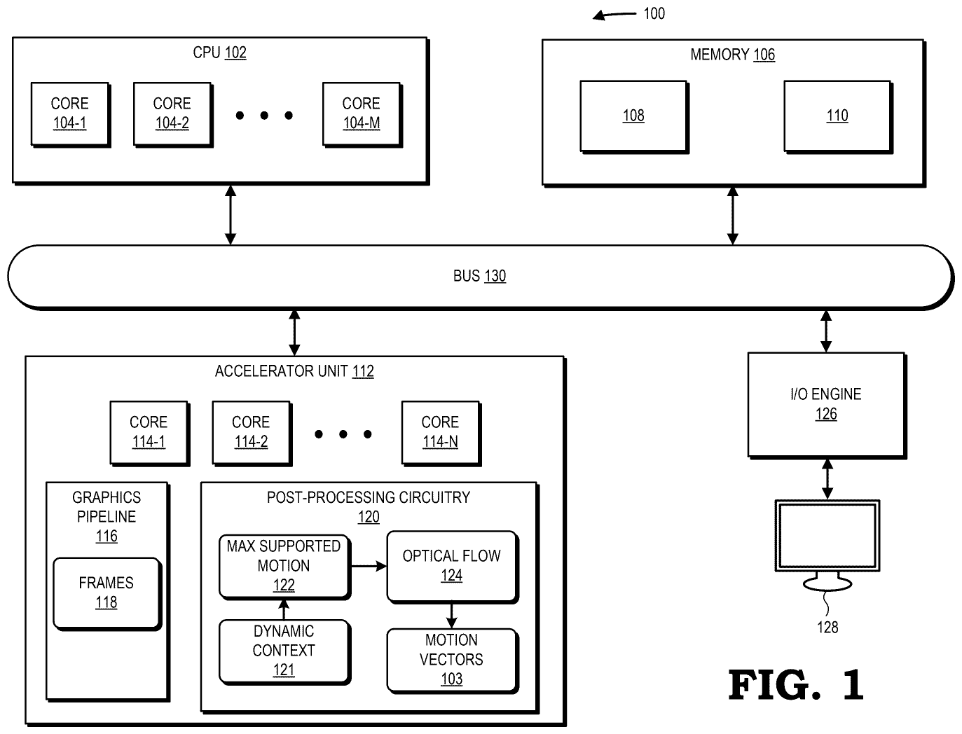

FIGS. 1-6 illustrate techniques for reducing the computation overhead associated with generating motion vectors. A processing system determines, based on one or more dynamic parameters, a maximum supported motion for one or more input image frames (sometimes referred to below as “frames” for simplicity) to an optical flow process. The processing system then adjusts the maximum limits of the optical flow process based on the maximum supported motion. The processing system thus tailors the limits of the optical flow process based on the expected amount of motion present in the one or more frames, thus making more efficient use of processor resources in the generation of the motion vectors.

To illustrate via an example, in some cases the amount of motion in different sets of frames is expected to differ based on the changing context of the processing system. For example, in some cases a game application generates images with relatively little motion (e.g., a game scene of a serene environment) and later generates images with a relatively large amount of movement (e.g., a game scene involving action with fast moving objects). Conventionally, an optical flow process calculates motion vectors for the different sets of images using the same maximum limits (e.g., based on the same search range and the same block size), resulting in the same or a similar number of motion vector computations for each set of images. Furthermore, in some cases, in order to ensure satisfactory image processing, the parameters of the optical flow process are set so that the generated motion vectors meet an expected amount of motion for the higher-motion set of images. That is, the parameters are set so that the generated motion vectors are likely to sufficiently capture the movement of objects in the set of images with greater motion. However, using the same parameters to generate motion vectors for the low motion set of image region does not improve the overall quality of the image processing output. Accordingly, using the techniques described herein, the maximum limits of the optical flow process are set based on dynamic context information indicating an expected amount of motion in a corresponding set of images. The context information is dynamically updated, so that the maximum limits of the optical flow process are adjusted as the expected amount of motion changes over time. The processing system thus maintains the overall quality of the image processing pipeline while reducing the overall number of calculations, and thus the amount of computer resources consumed by the generation of motion vectors.

The processing system identifies the dynamic context information, and thus the expected level of motion for a set of images, in any of a number of ways. For example, in some embodiments the processing system employs a pre-pass of one or more of the set of images to identify the maximum supported motion for the set of images. In some embodiments, the pre-pass includes performing a coarse search (e.g., a search employing a relatively large pixel block size as compared to the block size employed by the optical flow process) to identify matching blocks between at least two images of the set of images. Based on the coarse search, the pre-pass identifies an expected maximum amount of motion in the set of images and sets the maximum supported motion for the optical flow process accordingly.

In some embodiments, the dynamic context information includes information provided by an application, such as an application type. For example, in some embodiments the application type indicates whether the application is a game application, an office productivity application, and the like. Based on the type of application, the processing system sets the maximum supported motion for the optical flow process. For example, in response to the application type being a game application (indicating the potential for a relatively high amount of motion in a corresponding set of images), the processing system sets the maximum supported motion to a relatively high level. In response to the application type changing to an office productivity application (indicating that a relatively small amount of motion between images is to be expected), the processing system adjusts the maximum supported motion to a relatively low level, thus conserving processing resources. In some embodiments, the information provided by the application indicates whether application expects a change in the amount of motion (e.g., a game indicating that the amount of motion in an upcoming set of images is expected to increase or decrease), and the processing system sets the maximum supported motion to account for the expected change in motion.

In some embodiments, the dynamic context information includes metadata that indicates other context information such as specified level of processor performance, an expected amount of processor activity, the type of hardware associated with the processing system (e.g., a display type, a graphics processing unit type, and the like), and other information. In some embodiments, the dynamic context information includes a quality of service (QOS) setting that is adjustable by an operating system, by applications, and the like, or any combination thereof, allowing the operating system and applications to adjust the maximum supported motion of the optical flow process over time. In some embodiments, the dynamic context information includes a power setting that indicates a power state of the processing system (e.g., one or more of a low-power state, a high-performance state, and the like). The power setting is adjustable by an operating system, application, or other module of the processing system. Thus, for example, if the operating system indicates via the power setting that the processing system is in a low power state, the processing system sets the maximum supported motion to a relatively low amount of motion to reduce the number of computations executed by the optical flow process and thus to conserve power. When the processing system enters a high-performance state, the operating system changes the power setting and in response the processing system increases the maximum supported motion, thereby increasing the amount of expected motion for the optical flow process.

Referring now to FIG. 1, a processing system 100 configured to generate motion vectors based on regions of interest is presented, in accordance with some embodiments. Processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 130 to support communication between entities implemented in the processing system 100, such as the memory 106. Some implementations of the processing system 100 include other buses, bridges, switches, routers, and the like, which are not shown in FIG. 1 in the interest of clarity.

The techniques described herein are, in different implementations, employed at accelerator unit (AU) 112. AU 112 includes, for example, vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs), or any combination thereof. AU 112 is configured to generate a set of frames 118 each representing respective scenes within a screen space (e.g., the space in which a scene is displayed) according to one or more applications 110 for presentation on a display 128. As an example, AU 112 renders graphics objects (e.g., sets of primitives) for a scene to be displayed so as to produce pixel values representing a frame 118. AU 112 to post-processing circuitry 120 for further processing, such as compression, object tracking, and other image processing operations. In some cases, the post-processing circuitry provides the results of the processing of frame 118 (e.g., pixel values) to display 128. The pixel values of the frame 118, for example, include color values (YUV color values, RGB color values), depth values (z-values), or both.

After receiving a rendered frame, display 128 uses the pixel values of the rendered frame to display the scene including the rendered graphics objects. To render the graphics objects, AU 112 implements processor cores 114-1 to 114-N that execute instructions concurrently or in parallel. For example, AU 112 executes instructions, operations, or both from a graphics pipeline 116 using processor cores 114 to render one or more graphics objects. A graphics pipeline 116 includes, for example, one or more steps, stages, or instructions to be performed by AU 112 in order to render one or more graphics objects for a scene. As an example, example graphics pipeline 200 includes data indicating an input assembler stage, vertex shader stage, hull shader stage, tessellator stage, domain shader stage, geometry shader stage, rasterizer stage, pixel shader stage, output merger stage, or any combination thereof to be performed by one or more processor cores 114 of AU 112 in order to render one or more graphics objects for a scene to be displayed.

In embodiments, one or more processor cores 114 of AU 112 each operate as a compute unit configured to perform one or more operations for one or more instructions received by AU 112. These compute units each include one or more single instruction, multiple data (SIMD) units that perform the same operation on different data sets to produce one or more results. For example, AU 112 includes one or more processor cores 114 each functioning as a compute unit that includes one or more SIMD units to perform operations for one or more instructions from a graphics pipeline 116. To facilitate the performance of operations by the compute units, AU 112 includes one or more command processors (not shown for clarity). Such command processors, for example, include circuitry configured to execute one or more instructions from a graphics pipeline 116 by providing data indicating one or more operations, operands, instructions, variables, register files, or any combination thereof to one or more compute units necessary for, helpful for, or aiding in the performance of one or more operations for the instructions. Though the example implementation illustrated in FIG. 1 presents AU 112 as having three processor cores (114-1, 114-2, 114-N) representing an N number of cores, the number of processor cores 114 implemented in AU 112 is a matter of design choice. As such, in other implementations, AU 112 can include any number of processor cores 114. Some implementations of AU 112 are used for general-purpose computing. For example, in embodiments, AU 112 is configured to receive one or more instructions, such as program code 108, from one or more applications 110 that indicate operations associated with one or more video tasks, physical simulation tasks, computational tasks, fluid dynamics tasks, or any combination thereof, to name a few. In response to receiving the program code 108, AU 112 executes the instructions for the video tasks, physical simulation tasks, computational tasks, and fluid dynamics tasks. AU 112 then stores information in the memory 106 such as the results of the executed instructions.

To process the frames 118, in embodiments, AU 112 includes post-processing circuitry 120. Post-processing circuitry 120, for example, is configured to execute an optical flow process 124 to generate one or more motion vectors 103. A motion vector 103, for example, represents the movement of one or more graphics objects from a first frame (e.g., previous frame) and a second frame (e.g., current frame) of the frames 118. As an example, a motion vector 103 represents the movement of one or more pixels from a first position in a first frame to a second position in a second frame. To generate such motion vectors 103, the optical flow process 124 is configured to implement one or more motion estimation techniques, for example, block-matching processes, phase correlation methods, pixel recursive processes, optical flow methods, or any combination thereof, to name a few. For example, in some embodiments, the optical flow process 124 is configured to receive a set of pixels, referred to herein as a block, and to generate a motion vector for each block by performing the one or more motion estimation techniques based on the corresponding block of pixels. To illustrate, in some embodiments the input frame is divided by the post-processing circuitry 120 into a set of N×M pixel blocks, where N and M are integers. The optical flow process 124 is configured to receive at least a subset of the N×M pixel blocks and to generate a motion vector for each of the received pixel blocks.

As described further herein the optical flow methods implemented by the optical flow process 124 are configurable based on one or more maximum limits, such as a maximum search range (representing the maximum range of the search of a previous image to locate a matching set of pixels for a received block), a maximum number of iterations (indicating the maximum number of iterations of a corresponding matching process are to be executed for a block), a maximum block size (representing the maximum size of the sets of pixels used by the optical flow process 124 for matching), and the like. These maximum limits are collectively referred to as the maximum supported motion 122.

Furthermore, in some embodiments, the post processing circuitry 120 is configured to dynamically set the maximum supported motion based on context information, referred to as dynamic context 121. The dynamic context 121 includes information indicating the context of the AU 112 and the processing system 100, an in particular indicates one or more of an expected amount of motion in an upcoming subset of the frames 118, a desired performance level of the AU 112, and the like, or any combination thereof. The dynamic context 121 is programmable (e.g., via one or more store operations that stores values in a set of registers or other storage structure corresponding to the dynamic context 121) and is updated based on changes in the operating context of the processing system 100. This allows an application (e.g., an application 110), an operating system, or other entity to change the maximum supported motion 122 by changing the dynamic context 121. Thus, for example, in some cases the processing system 100 sets the dynamic context 121 for a first set of frames to indicate a relatively low amount of expected motion. In response, the post-processing circuitry 120 sets the maximum supported motion 122 to a relatively low value (e.g., setting the search range to a relatively low value, setting a block size to a relatively high value, or a combination thereof). The optical flow process 124 generates motion vectors 103 for the first set of frames based on the maximum supported motion 122. Subsequently, for a second set of frames, to indicate a relatively high amount of expected motion. In response, the post-processing circuitry 120 sets the maximum supported motion 122 to a relatively low value (e.g., setting the search range to a relatively high value, setting a block size to a relatively low value, or a combination thereof). The optical flow process 124 generates motion vectors 103 for the first set of frames based on the adjusted maximum supported motion 122. Thus, the processing system 100 changes the maximum supported motion 122 as the dynamic context 121 changes, and thereby tailors the parameters of the optical flow process 124 to the expected motion in each upcoming set of frames.

In some embodiments, processing system 100 includes input/output (I/O) engine 126 that includes circuitry to handle input or output operations associated with display 128, as well as other elements of the processing system 100 such as keyboards, mice, printers, external disks, and the like. The I/O engine 126 is coupled to the bus 130 so that the I/O engine 126 communicates with the memory 106, AU 112, or the central processing unit (CPU) 102.

In embodiments, processing system 100 also includes CPU 102 that is connected to the bus 130 and therefore communicates with AU 112 and the memory 106 via the bus 130. CPU 102 implements a plurality of processor cores 104-1 to 104-M that execute instructions concurrently or in parallel. In implementations, one or more of the processor cores 104 operate as SIMD units that perform the same operation on different data sets. Though in the example implementation illustrated in FIG. 1, three processor cores (104-1, 104-2, 104-M) are presented representing an M number of cores, the number of processor cores 104 implemented in CPU 102 is a matter of design choice. As such, in other implementations, CPU 102 can include any number of processor cores 104. In some implementations, CPU 102 and AU 112 have an equal number of processor cores 104, 114 while in other implementations, CPU 102 and AU 112 have a different number of processor cores 104, 114. The processor cores 104 of CPU 102 are configured execute instructions such as program code 108 for one or more applications 110 (e.g., graphics applications, compute applications, machine-learning applications) stored in the memory 106, and CPU 102 stores information in the memory 106 such as the results of the executed instructions. CPU 102 is also able to initiate graphics processing by issuing draw calls to AU 112.

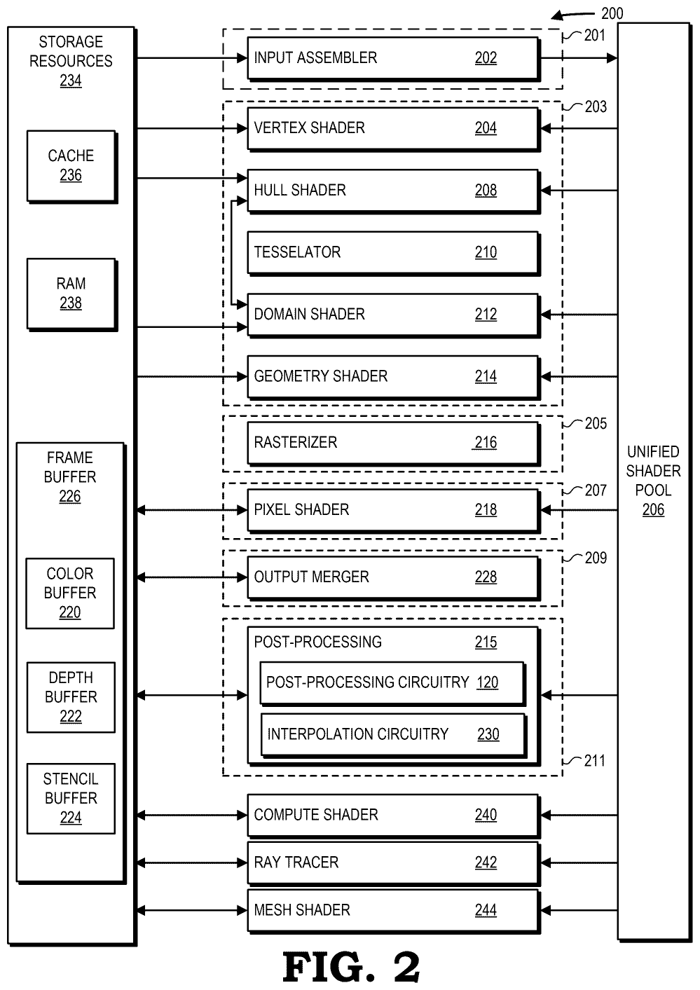

Referring now to FIG. 2, a block diagram of an example graphics pipeline 200 is presented, in accordance with some embodiments. In embodiments, example graphics pipeline 200 is implemented in processing system 100 as graphics pipeline 116. In embodiments, example graphics pipeline 200 is configured to render graphics objects as images that depict a scene which has three-dimensional geometry in virtual space (also referred to herein as “screen space”), but potentially a two-dimensional geometry. Example graphics pipeline 200 typically receives a representation of a three-dimensional scene, processes the representation, and outputs a two-dimensional raster image. These stages of example graphics pipeline 200 process data that is initially properties at end points (or vertices) of a geometric primitive, where the primitive provides information on an object being rendered. Typical primitives in three-dimensional graphics include triangles and lines, where the vertices of these geometric primitives provide information on, for example, x-y-z coordinates, texture, and reflectivity.

According to embodiments, example graphics pipeline 200 has access to storage resources 234 (also referred to herein as “storage components”). Storage resources 234 include, for example, a hierarchy of one or more memories or caches that are used to implement buffers and store vertex data, texture data, and the like, for example graphics pipeline 200. In some embodiments, storage resources 234 are implemented within processing system 100 using respective portions of system memory 106. In embodiments, storage resources 234 include or otherwise have access to one or more caches 236, one or more random access memory (RAM) units 238, video random access memory unit(s) (not pictured for clarity), one or more processor registers (not pictured for clarity), and the like, depending on the nature of data at the particular stage of example graphics pipeline 200. Accordingly, it is understood that storage resources 234 refer to any processor-accessible memory utilized in the implementation of example graphics pipeline 200.

Example graphics pipeline 200, for example, includes stages that each perform respective functionalities. For example, these stages represent subdivisions of functionality of example graphics pipeline 200. Each stage is implemented partially or fully as shader programs executed by AU 112. According to embodiments, stages 201 and 203 of example graphics pipeline 200 represent the front-end geometry processing portion of example graphics pipeline 200 prior to rasterization. Stages 203 to 211 represent the back-end pixel processing portion of example graphics pipeline 200.

During input assembler stage 201 of example graphics pipeline 200, an input assembler 202 is configured to access information from the storage resources 234 that is used to define objects that represent portions of a model of a scene. For example, in various embodiments, the input assembler 202 includes circuitry configured to read primitive data (e.g., points, lines and/or triangles) from user-filled buffers (e.g., buffers filled at the request of software executed by processing system 100, such as an application 110) and assembles the data into primitives that will be used by other pipeline stages of the example graphics pipeline 200. “User,” as used herein, refers to an application 110 or other entity that provides shader code and three-dimensional objects for rendering to example graphics pipeline 200. In embodiments, the input assembler 202 is configured to assemble vertices into several different primitive types (e.g., line lists, triangle strips, primitives with adjacency) based on the primitive data include in the user-filled buffers and formats the assembled primitives for use by the rest of example graphics pipeline 200.

According to embodiments, example graphics pipeline 200 operates on one or more virtual objects defined by a set of vertices set up in the screen space and having geometry that is defined with respect to coordinates in the scene. For example, the input data utilized in example graphics pipeline 200 includes a polygon mesh model of the scene geometry whose vertices correspond to the primitives processed in the rendering pipeline in accordance with aspects of the present disclosure, and the initial vertex geometry is set up in the storage resources 234 during an application stage implemented by, for example, CPU 102.

During the vertex processing stage 203 of example graphics pipeline 200, one or more vertex shaders 204 are configured to process vertexes of the primitives assembled by the input assembler 202. For example, a vertex shader 204 includes circuitry configured to first receive a single vertex of a primitive as an input and outputs a single vertex. The vertex shader 204 then performs various per-vertex operations such as transformations, skinning, morphing, per-vertex lighting, or any combination thereof, to name a few. Transformation operations include various operations to transform the coordinates (e.g., X-Y coordinate, Z-depth values) of the vertices. These operations include, for example, one or more modeling transformations, viewing transformations, projection transformations, perspective division, viewport transformations, or any combination thereof. Herein, such transformations are considered to modify the coordinates or “position” of the vertices on which the transforms are performed. Other operations of the vertex shader 204 modify attributes other than the coordinates.

In embodiments, one or more vertex shaders 204 are implemented partially or fully as vertex shader programs to be executed on one or more processor cores 114 (e.g., one or more processor cores 114 operating as compute units). Some embodiments of shaders such as the vertex shader 204 implement massive single-instruction-multiple-data (SIMD) processing so that multiple vertices are processed concurrently. In at least some embodiments, example graphics pipeline 200 implements a unified shader model so that all the shaders included in example graphics pipeline 200 have the same execution platform on the shared massive SIMD units of the processor cores 114. In such embodiments, the shaders, including one or more vertex shaders 204, are implemented using a common set of resources that is referred to herein as the unified shader pool 206.

During the vertex processing stage 203, in some embodiments, one or more vertex shaders 204 perform additional vertex processing computations that subdivide primitives and generate new vertices and new geometries in the screen space. These additional vertex processing computations, for example, are performed by one or more of a hull shader 208, a tessellator 210, a domain shader 212, and a geometry shader 214. The hull shader 208, for example, includes circuitry configured to operate on input high-order patches or control points that are used to define the input patches. Additionally, the hull shader 208 outputs tessellation factors and other patch data. According to embodiments, within example graphics pipeline 200, primitives generated by the hull shader 208 are provided to the tessellator 210. The tessellator 210 includes circuitry configured to receive objects (such as patches) from the hull shader 208 and generate information identifying primitives corresponding to the input object, for example, by tessellating the input objects based on tessellation factors provided to the tessellator 210 by the hull shader 208. Tessellation, as an example, subdivides input higher-order primitives such as patches into a set of lower-order output primitives that represent finer levels of detail (e.g., as indicated by tessellation factors that specify the granularity of the primitives produced by the tessellation process). As such, a model of a scene is represented by a smaller number of higher-order primitives (e.g., to save memory or bandwidth) and additional details are added by tessellating the higher-order primitive.

The domain shader 212 includes circuitry configured to receive a domain location, other patch data, or both as inputs. The domain shader 212 is configured to operate on the provided information and generate a single vertex for output based on the input domain location and other information. The geometry shader 214 includes circuitry configured to receive a primitive as an input and generate up to four primitives based on the input primitive. In some embodiments, the geometry shader 214 retrieves vertex data from storage resources 234 and generates new graphics primitives, such as lines and triangles, from the vertex data in storage resources 234. In particular, the geometry shader 214 retrieves vertex data for a primitive and generates one or more primitives. To this end, for example, the geometry shader 214 is configured to operate on a triangle primitive with three vertices. A variety of different types of operations can be performed by the geometry shader 214, including operations such as point sprint expansion, dynamic particle system operations, fur-fin generation, shadow volume generation, single pass render-to-cubemap, per-primitive material swapping, per-primitive material setup, or any combination thereof. According to embodiments, the hull shader 208, the domain shader 212, the geometry shader 214, or any combination thereof are implemented as shader programs to be executed on the processor cores 114, whereas the tessellator 210, for example, is implemented by fixed-function hardware.

Once front-end processing (e.g., stages 201, 203) of example graphics pipeline 200 is complete, the scene is defined by a set of vertices which each have a set of vertex parameter values stored in the storage resources 234. In certain implementations, the vertex parameter values output from the vertex processing stage 203 includes positions defined with different homogeneous coordinates for different zones.

As described above, stages 205 to 211 represent the back-end processing of example graphics pipeline 200. The rasterizer stage 205 includes a rasterizer 216 having circuitry configured to accept and rasterize simple primitives that are generated upstream. The rasterizer 216 is configured to perform shading operations and other operations such as clipping, perspective dividing, scissoring, viewport selection, and the like. In embodiments, the rasterizer 216 is configured to generate a set of pixels that are subsequently processed in the pixel processing/shader stage 207 of the example graphics processing pipeline. In some implementations, the set of pixels includes one or more tiles. In one or more embodiments, the rasterizer 216 is implemented by fixed-function hardware.

The pixel processing stage 207 of example graphics pipeline 200 includes one or more pixel shaders 218 that include circuitry configured to receive a pixel flow (e.g., the set of pixels generated by the rasterizer 216) as an input and output another pixel flow based on the input pixel flow. To this end, a pixel shader 218 is configured to calculate pixel values for screen pixels based on the primitives generated upstream and the results of rasterization. In embodiments, the pixel shader 218 is configured to apply textures from a texture memory, which, according to some embodiments, is implemented as part of the storage resources 234. The pixel values generated by one or more pixel shaders 218 include, for example, color values, depth values, and stencil values, and are stored in one or more corresponding buffers, for example, a color buffer 220, a depth buffer 222, and a stencil buffer 224, respectively. The combination of the color buffer 220, the depth buffer 222, the stencil buffer 224, or any combination thereof is referred to as a frame buffer 226. In some embodiments, example graphics pipeline 200 implements multiple frame buffers 226 including front buffers, back buffers and intermediate buffers such as render targets, frame buffer objects, and the like. Operations for the pixel shader 218 are performed by a shader program that executes on the processor cores 114.

According to embodiments, the pixel shader 218, or another shader, accesses shader data, such as texture data, stored in the storage resources 234. Such texture data defines textures which represent bitmap images used at various points in example graphics pipeline 200. For example, the pixel shader 218 is configured to apply textures to pixels to improve apparent rendering complexity (e.g., to provide a more “photorealistic” look) without increasing the number of vertices to be rendered. In another instance, the vertex shader 204 uses texture data to modify primitives to increase complexity, by, for example, creating or modifying vertices for improved aesthetics. AS an example, the vertex shader 204 uses a height map stored in storage resources 234 to modify displacement of vertices. This type of technique can be used, for example, to generate more realistic-looking water as compared with textures only being used in the pixel processing stage 207, by modifying the position and number of vertices used to render the water. The geometry shader 214, in some embodiments, also accesses texture data from the storage resources 234.

Within example graphics pipeline 200, the output merger stage 209 includes an output merger 228 accepting outputs from the pixel processing stage 207 and merges these outputs. As an example, in embodiments, output merger 228 includes circuitry configured to perform operations such as z-testing, alpha blending, stenciling, or any combination thereof on the pixel values of each pixel received from the pixel shader 218 to determine the final color for a screen pixel. For example, the output merger 228 combines various types of data (e.g., pixel values, depth values, stencil information) with the contents of the color buffer 220, depth buffer 222, and, in some embodiments, the stencil buffer 224 and stores the combined output back into the frame buffer 226. The output of the output merger stage 209 can be referred to as rendered pixels that collectively form a rendered frame 118. In one or more implementations, the output merger 228 is implemented by fixed-function hardware.

In embodiments, example graphics pipeline 200 includes a post-processing stage 211 implemented after the output merger stage 209. During the post-processing stage 211, post-processing circuitry 120 operates on the rendered frame stored (or individual pixels) stored in the frame buffer 226 to apply one or more post-processing effects, such as ambient occlusion or tonemapping, prior to the frame being output to the display. The post-processed frame is written to a frame buffer 226, such as a back buffer for display or an intermediate buffer for further post-processing. The example graphics pipeline 200, in some embodiments, includes other shaders or components, such as a computer shader 240, a ray tracer 242, a mesh shader 244, and the like, which are configured to communicate with one or more of the other components of example graphics pipeline 200.

In embodiments, to help improve the frame rate of a set of rendered frames 118 rendered by the example graphics pipeline 200, post-processing stage 215 includes interpolation circuitry 230. Interpolation circuitry 230, according to some embodiments, is implemented within or otherwise connected to post-processing circuitry 120. To generate an interpolated frame, post-processing circuitry 120 is configured to generate one or more motion vectors 103 based on two or more frames 118. For example, post-processing circuitry 120 first retrieves pixel data (e.g., color values, depth values) of a first frame (e.g., current frame) from respective color buffers 220 and depth buffers 222 associated with the first rendered frame. Further, post-processing circuitry 120 retrieves pixel data of a second rendered frame (e.g., previous frame) from respective color buffers 220 and depth buffers 222 associated with the second rendered frame. In embodiments, the second rendered frame is the frame within a set of rendered frames 118 immediately preceding the first frame. post-processing circuitry 120 then implements one or more motion estimation techniques based on the pixel values associated with the first rendered frame and the pixel values associated with the second rendered frame to output one or more motion vectors 103. Based on one or of the determined motion vectors 103, interpolation circuitry 230 is configured to generate pixel values (e.g., color values, depth values, stencil values) for an interpolated frame that represents a scene temporally between, spatially between, or both the first rendered frame and the second rendered frame.

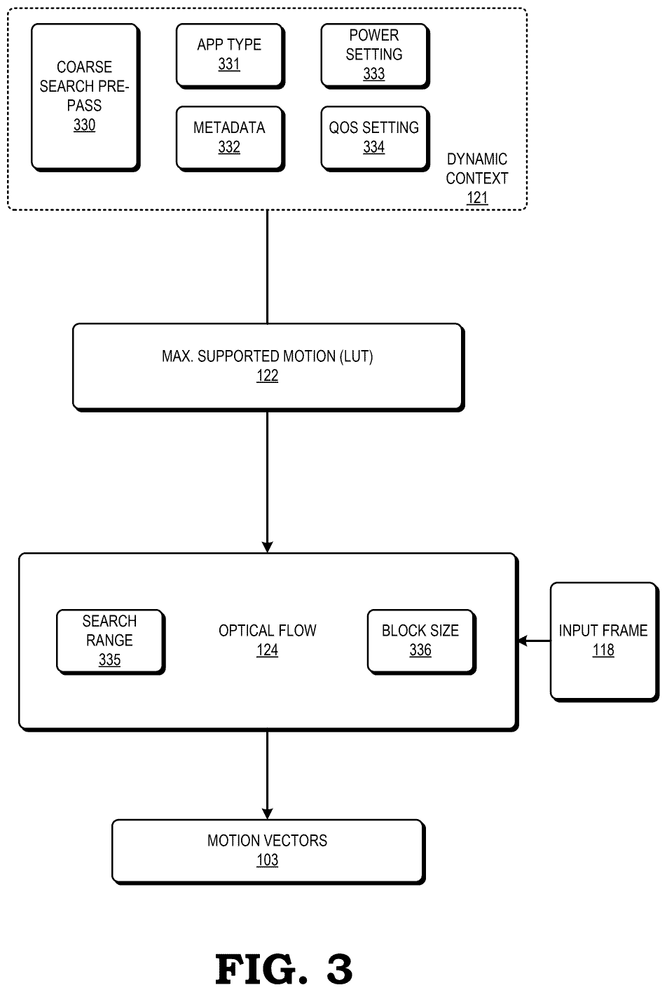

FIG. 3 illustrates an example of the post-processing circuitry 120 generating motion vectors for input frames based on a dynamic maximum supported motion 122. In the illustrated example, the post-processing circuitry 120 is configured to employ a look-up table (LUT) or other structure that includes a plurality of entries. Each entry stores a set of dynamic context values (or value ranges) and a corresponding set of maximum supported motion values (e.g., a block size 336, a search range 335, a number of iterations, and the like). Periodically, or in response to specified system events, or any combination thereof, the post-processing circuitry 120 identifies the state of the dynamic context 121 and matches the state to one of the entries of the LUT. The post-processing circuitry 120 retrieves the maximum supported motion values 122 from the LUT and provides the retrieved values to the optical flow process 124. The optical flow process 124 uses the provided values to generate the motion vectors 103 for one or more input frames (e.g., input frame 118). For example, in some embodiments the optical flow process separates the input frame 118 into a set of blocks having the block size 336, and searches for matching blocks (in a previous reference image) within the search range 335, as indicated by the maximum supported motion 122.

In the illustrated example, the dynamic context information 121 includes pre-pass information 330, application type information 331, metadata 332, power setting information 333 and a QoS setting 334. It will be appreciated that the dynamic context information 121 is an example only, and that in different embodiments the dynamic context information includes less or more information than is depicted. For example, in some embodiments the dynamic context information includes only one of the pre-pass information 330, application type information 331, metadata 332, power setting information 333 and a QoS setting 334.

The pre-pass information 330 is information reflecting the results of a pre-pass of one or more of a set of images before the optical flow process 124 generates motion vectors based on those images. In some embodiments, the pre-pass is executed by the post-processing circuitry 120 to match blocks of a first image to blocks of a second image, and to identify a maximum displacement between the matched blocks. The maximum displacement indicates the maximum expected motion in the set of images including the first image and the second image. Furthermore, in some embodiments the pre-pass is a coarser search for matching blocks than the block matching performed by the optical flow process 124, so that the pre-pass is executed more quickly by the post-processing circuitry 120. For example, in some embodiments the pre-pass employs a larger block size than the block size 336 used by the optical flow process 124. The post-processing circuitry thereby employs the pre-pass to quickly identify an expected maximum amount of motion in a set of images and sets the maximum supported motion 122 based on the expected maximum amount of motion.

The application type information 331 is information provided by an application, such as an application type, allowing the processing system 100 to change the maximum supported motion 122 depending on the type of application generating the frames 118. For example, in some embodiments the application type indicates a game application at a first time, and the maximum supported motion 122 in response is set to a relatively high supported motion to account for the relatively high amount of expected motion associated with a game program. Later, at a second time, the application type indicates a web browsing application and the maximum supported motion 122 in response is set to a relatively low supported motion to account for the relatively low amount of expected motion associated with a web browsing program. In some embodiments, the application type 331 is provided by the application itself. In other embodiments the application type 331 is identified by an operating system.

The metadata 332 includes context information set by an application, an operating system, hardware of the processing system 100, or any combination thereof, and indicates characteristics of an executing application, of the processing system 100, and the like, or any combination thereof. For example, in some embodiments the metadata 332 includes information indicating a specified level of processor performance, an expected amount of processor activity, the type of hardware associated with the processing system 100 (e.g., a display type, a graphics processing unit type, and the like), and other information.

The QoS setting 334 is a programmable setting (e.g., by an operating system or application) that indicates a specified level of service for one or more aspects of the processing system 100, including the optical flow process 124. For example, in some embodiments the QoS setting 334 is programmed by an application to increase or decrease the maximum supported motion 122 based on one or more conditions identified by the application. The QoS setting 334 thus provides a simple way for a programmer of the application to set or influence the maximum supported motion 122.

The power setting 333 is data indicating a power state of the processing system 100. For example, in some embodiments the processing system 100 is configured to operate in any of a plurality of power states depending on specified conditions, such as one or more of a low-power state and a high-performance state. If the power setting 333 indicates that the processing system is in the low power state, the processing system 100 sets the maximum supported motion 122 to a relatively low amount of motion to reduce the number of computations executed by the optical flow process 124 and thus to conserve power. If the power setting 333 indicates that the processing system is in the high-performance state, the processing system 100 sets the maximum supported motion 122 to a relatively high amount of motion, thereby increasing the amount of expected motion for the optical flow process 124.

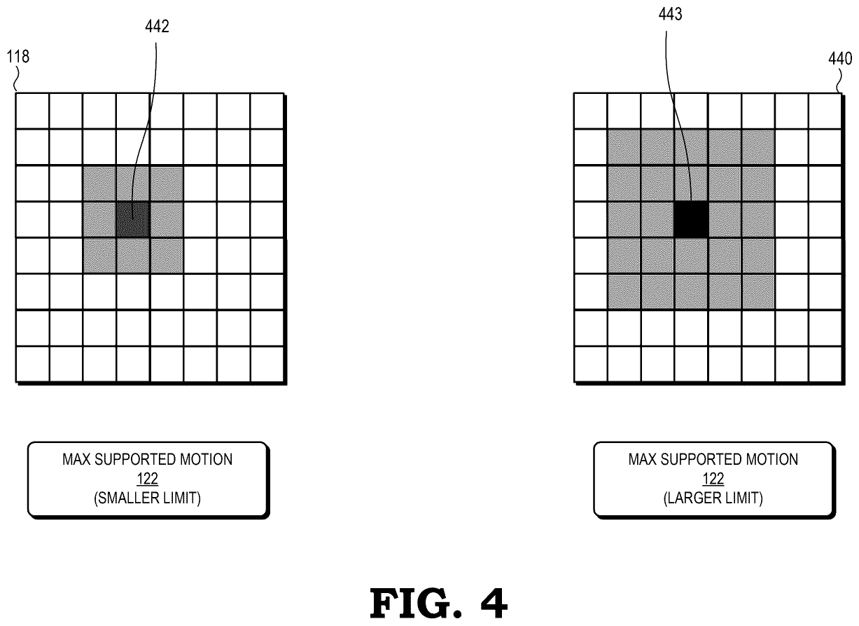

FIG. 4 indicates an example of the processing system 100 employing different search ranges for different input frames to the optical flow process 124 in accordance with some embodiments. In the illustrated example, for a first frame 118, the processing system 100 has set (based on the dynamic context information 121) the maximum supported motion 122 to a relatively small amount of motion. This results in the search range 335 being placed at a relatively small range of one block. That is, to generate motion vectors for the frame 118, the optical flow process 124 searches a reference image (not shown) for matching blocks (e.g., blocks that match a block 442) in a one block radius (e.g., a one block radius of the position of the block 442).

Subsequently, for a frame 440, the processing system 100 has set (based on changes to the dynamic context information 121) the maximum supported motion 122 to a relatively large amount of motion. Accordingly, the search range 335 is set at a relatively large range of two blocks. That is, to generate motion vectors for the frame 440, the optical flow process 124 searches a reference image (not shown) for matching blocks (e.g., blocks that match a block 443) in a one block radius (e.g., a one block radius of the position of the block 443). In some embodiments, the frames 118 and 440 are generated by the same application. That is, the processing system 100 employs different maximum supported motion values for different frames generated by a single application, based on changing context of the application.

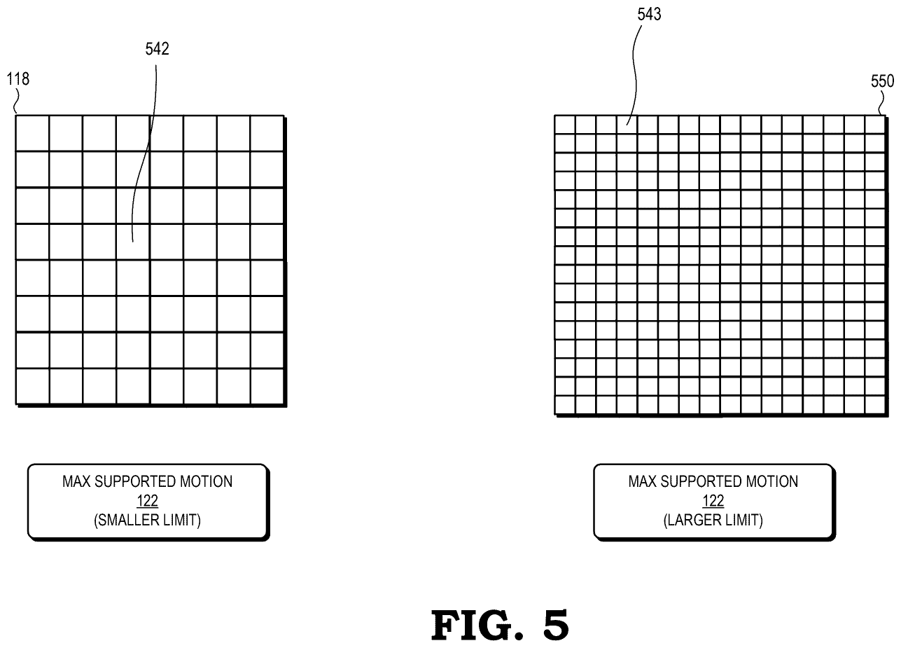

FIG. 5 indicates an example of the processing system 100 employing different block sizes for different input frames to the optical flow process 124 in accordance with some embodiments. In the illustrated example, for a first frame 118, the processing system 100 has set (based on the dynamic context information 121) the maximum supported motion 122 to a relatively small amount of motion. This results in the block size 336 being placed at a relatively large size. That is, to generate motion vectors for the frame 118, the optical flow process 124 divides the frame 118 into sixty-four blocks (e.g., block 542) having the same size, and searches a reference image for matching blocks.

Subsequently, for a frame 550, the processing system 100 has set (based on changes to the dynamic context information 121) the maximum supported motion 122 to a relatively large amount of motion. Accordingly, the block size 336 is set to a relatively small size. That is, to generate motion vectors for the frame 118, the optical flow process 124 divides the frame 550 into two-hundred fifty-six blocks (e.g., block 543) having the same size, and searches a reference image for matching blocks. The blocks for the frame 550 are thus smaller than the blocks of the frame 118, allowing the optical flow process to identify motion vectors for more objects, or with more granularity. It will be appreciated that FIGS. 4 and 5 are examples, and that in other embodiments changes in the maximum supported motion 122 changes both the block size and search range employed by the optical flow process 124 or changes different or additional aspects of the optical flow process 124, such as a number of iterations of one or more calculations executed by the optical flow process 124.

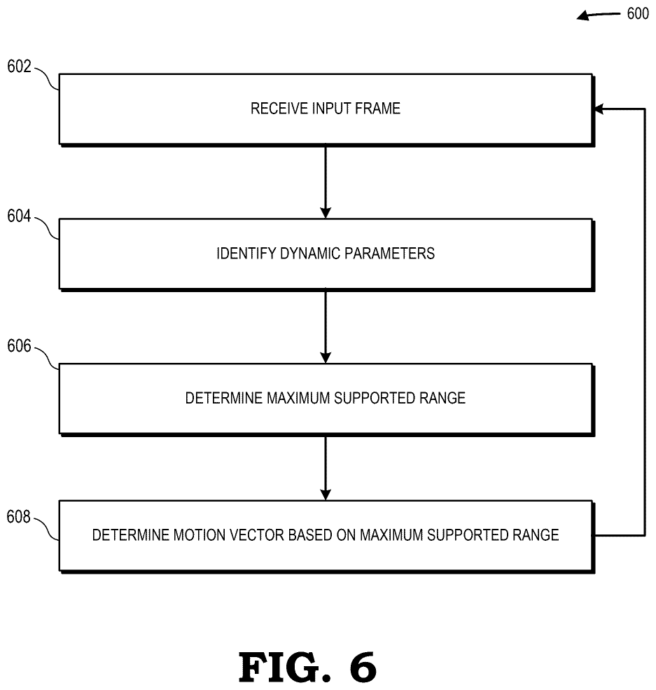

FIG. 6 illustrates a flow diagram of a method 600 of generating motion vectors for frames based on dynamic maximum supported motion in accordance with some embodiments. For purposes of description, the method 600 is described with respect to an example implementation at the processing system 100 of FIG. 1, but it will be appreciated that in other embodiments the method 600 is implemented at processing systems having different configurations.

At block 602, post-processing circuitry 120 receives a frame, such as frame 118, for which motion vectors are to be generated (e.g., for interpolation, frame compression, object tracking, and the like). At block 604, the post-processing circuitry 120 identifies the current state of the dynamic context information 121. For example, in different embodiments, the post-processing circuitry 120 identifies one or more of a type of application being executed, information provided by the application (e.g., an expected level of motion), a power setting of the processing system 100, a QoS setting, metadata, and the like. Further, the dynamic context information 121 is dynamic information that changes based on requests by an application, based on changing operating conditions of the processing system 100, and the like, or any combination thereof. Moreover, in some embodiments the post-processing circuitry sets the state of the dynamic context information 121 by executing a pre-pass of the received frame to determine an expected maximum amount of motion in the frame. In some embodiments, the pre-pass is a coarse search, relative to the search performed by the optical flow process 124, to find matching blocks between the received frame and a reference frame. The coarse search indicates the maximum expected motion for the received frame.

At block 606, the post-processing circuitry 120 employs the dynamic context information 121 to set the maximum supported motion 122. For example, in some embodiments the post-processing circuitry 120 employs a look-up table (LUT) or other structure that includes a plurality of entries. Each entry stores a set of dynamic context values (or value ranges) and a corresponding set of maximum supported motion values (e.g., a block size 336, a search range 335, a number of iterations, and the like). The post-processing circuitry 120 identifies an entry of the LUT based on the current state of the dynamic context information 121 and retrieves the maximum supported motion values 122 from the identified entry of the LUT. At block 608, the optical flow process 124 uses the retrieved maximum supported motion values to generate the motion vectors 103 for the received frame. For example, in some embodiments the optical flow process separates the input frame 118 into a set of blocks having the block size 336, and searches for matching blocks (in a previous reference image) within the search range 335, as indicated by the maximum supported motion 122. The method flow returns to block 602 and the post-processing circuitry 120 begins generation of motion vectors for another frame, based on different maximum supported motion values for the optical flow process 124. The processing system 100 thus generates motion vectors for different frames having different expected motion, while conserving processing resources.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
identifying, for each of a plurality of image frames, a dynamic maximum supported range of motion; and
generating, at a processing unit, motion vectors for each of the plurality of image frames based on the corresponding maximum supported range of motion.

2. The method of claim 1, wherein generating the motion vectors comprises:
setting, for each of the plurality of image frames, a search range based on the corresponding maximum supported range of motion; and
generating the motion vectors based on the search range for each of the plurality of image frames.

3. The method of claim 1, wherein generating the motion vectors comprises:
setting, for each of the plurality of image frames, a block size based on the corresponding maximum supported range of motion; and
generating the motion vectors based on the block size for each of the plurality of image frames.

4. The method of claim 1, wherein identifying the dynamic maximum supported range of motion comprises identifying the dynamic maximum supported range of motion based on information provided by an executing application.

5. The method of claim 1, wherein identifying the dynamic maximum supported range of motion comprises identifying the dynamic maximum supported range of motion based on a pre-pass of the plurality of image frames.

6. The method of claim 5, wherein the pre-pass comprises a search for matching blocks between the plurality of image frames.

7. The method of claim 1, wherein identifying the dynamic maximum supported range of motion comprise identifying the dynamic maximum supported range of motion based on one or more of metadata provided by an application, an application type, a power setting, and a quality-of-service parameter.

8. A method, comprising:
identifying a first maximum supported range of motion for a first frame of a plurality of image frames and a second maximum supported range of motion for a second frame of the plurality of image frames;
generating, at a processing unit, motion vectors for the first frame based on the first maximum supported range of motion; and
generating, at the processing unit, motion vectors for the second frame based on the second maximum supported range of motion.

9. The method of claim 8, wherein:
generating the motion vectors for the first frame comprises setting a first search range based on the first maximum supported range of motion; and
generating the motion vectors for the second frame comprises setting a second search range based on the second maximum supported range of motion, the second search range different from the first search range.

10. The method of claim 8, wherein:
generating the motion vectors for the first frame comprises setting a first block size based on the first maximum supported range of motion; and
generating the motion vectors for the second frame comprises setting a second block size based on the second maximum supported range of motion, the second block size different from the first block size.

11. The method of claim 8, wherein identifying the first maximum supported range of motion comprises identifying the first maximum supported range of motion based on information provided by an executing application.

12. The method of claim 8, wherein identifying the first maximum supported range of motion comprises identifying the first maximum supported range of motion based on a pre-pass of the first frame.

13. The method of claim 12, wherein the pre-pass comprises a search for matching blocks between the first frame and a reference frame.

14. The method of claim 8, wherein identifying the first maximum supported range of motion comprises identifying the first maximum supported range of motion based on one or more of metadata provided by an application, an application type, a power setting, and a quality-of-service parameter.

15. A processing system comprising:
a processor including one or more processor cores configured to:
identify, for each of a plurality of image frames, a dynamic maximum supported range of motion; and
generate, at a processing unit, motion vectors for each of the plurality of image frames based on the corresponding maximum supported range of motion.

16. The processing system of claim 15, wherein the processing system is to generate the motion vectors by:
setting, for each of the plurality of image frames, a search range based on the corresponding maximum supported range of motion; and
generating the motion vectors based on the search range for each of the plurality of image frames.

17. The processing system of claim 15, wherein the processing system is to generate the motion vectors by:
setting, for each of the plurality of image frames, a block size based on the corresponding maximum supported range of motion; and
generating the motion vectors based on the block size for each of the plurality of image frames.

18. The processing system of claim 15, wherein the processing system is to identify the dynamic maximum supported range of motion based on information provided by an executing application.

19. The processing system of claim 15, wherein the processing system is to identify the dynamic maximum supported range of motion by identifying the dynamic maximum supported range of motion based on a pre-pass of the plurality of image frames.

20. The processing system of claim 19, wherein the pre-pass comprises a search for matching blocks between the plurality of images.
